(19) United States
(12) Patent Application Publication
(10) Pub. No.: US 2025/0230528 A1
(43) Pub. Date: Jul. 17, 2025

(54) HIGH-STRENGTH HEAT-RESISTANT ALUMINUM-BASED COMPOSITE MATERIAL AND PREPARATION METHOD THEREFOR

(71) Applicant: HUNAN WENCHANG NEW MATERIAL TECHNOLOGY CO.,LTD., Loudi City, Hunan Province (CN)

(72) Inventors: Jun XU, Loudi City, Hunan Province (CN); Zhenlin ZHANG, Loudi City, Hunan Province (CN); Xianqing LI, Loudi City, Hunan Province (CN); Min HE, Loudi City, Hunan Province (CN)

(73) Assignee: HUNAN WENCHANG NEW MATERIAL TECHNOLOGY CO.,LTD., Loudi City, Hunan Province (CN)

(21) Appl. No.: 18/703,207

(22) PCT Filed: Nov. 8, 2021
(86) PCT No.: PCT/CN2021/129304

§ 371 Date: Sep. 13, 2024

(30) Foreign Application Priority Data
Oct. 29, 2021 (CN) 202111276923.6

(51) Int. Cl. C22C 32/00; C22C 1/10; F16D 65/12

(52) U.S. Cl. CPC C22C 32/0063; C22C 1/1005; C22C 1/1047; F16D 65/125

(57) ABSTRACT

An aluminum-based composite material and a brake disc made of the composite material are provided. The material includes a base material and a reinforcing phase. The base material includes the following components in mass percentage: 4.0-7.0% of Cu, 0.4-1.2% of Mg, and 0.1-0.8% of Ag, with the balance being Al. The reinforcing phase can be SiC particles having a volume percentage of 10-40%.

### TECHNICAL FIELD

The present disclosure relates to the technical field of aluminum alloy materials, and specifically to a high-strength heat-resistant aluminum matrix composite material and a method for preparing the high-strength heat-resistant aluminum matrix composite material.

### BACKGROUND

The braking performance of brake discs directly affects the safety of vehicle driving. In rail transit and automotive braking systems, due to frequent braking and high speed of the vehicle, a surface temperature of the brake disc may reach 300° C.-400° C. during the braking process. It is difficult for ordinary aluminum alloys to maintain high performance at such a temperature, and softening may occur.

SiC particle reinforced aluminum matrix composite material is an aluminum matrix composite material widely used in traffic braking systems. It not only has the characteristics of low density and good thermal conductivity of Al matrix, but also has the advantages of high wear resistance, high hardness and low coefficient of expansion of SiC particle component. On the premise of meeting usage requirements, using SiCp/Al composite brake disc to replace traditional cast iron or cast steel brake disc can reduce the weight of brake disc by 50%-60%, and can bring advantages such as no noise and no hot spots during braking, and long service life. At present, the aluminum matrix composite materials used for traffic braking mainly include SiCp/A356 composite material. However, this material has certain limitations, and it is only suitable for traffic braking systems with a speed below 120 km/h. For high-speed trains and automobiles, the high temperature generated during braking can easily lead to softening of SiCp/A356 composite material, resulting in decreased braking performance and lower high-temperature resistance.

Therefore, in order to ensure the high-temperature resistance of aluminum alloy composite material while also achieving the object of energy conservation, weight reduction and efficiency improvement in rail transit and automotive systems, it is necessary to improve the matrix aluminum alloy to produce an aluminum alloy composite material with both excellent high-temperature resistance and high wear resistance, so that rail transit brake discs can still meet service requirements in high-temperature environments.

### SUMMARY

An object of the present disclosure is to overcome the disadvantages in the prior art, and provide an aluminum matrix composite material, which has both excellent high-temperature resistance and high wear resistance. A brake disc made of the aluminum matrix composite material can still meet service requirements in high-temperature environments.

Another object of the present disclosure is to provide a method for preparing the aluminum matrix composite material.

In order to achieve the above objects, the present disclosure provides the following technical solutions.

An aluminum matrix composite material is provided, which includes:
a matrix material, which includes following components by mass percentage: 4.0%-7.0% of Cu, 0.4%-1.2% of Mg, 0.1%-0.8% of Ag, and balance being Al; and
a reinforcing phase, which is SiC particles with a volume percentage of 10%-40%.

In a preferred embodiment, the aluminum matrix composite material is composed of the following components:
a matrix material, which is composed of the following components by mass percentage: 4.0%-7.0% of Cu, 0.4%-1.2% of Mg, and 0.1%-0.8% of Ag, with the balance being Al; and
a reinforcing phase, which is SiC particles with a volume percentage of 10%-40%.

In a preferred embodiment, the aluminum matrix composite material further includes 0.05%-0.5% of Mn, 0.05%-0.5% of Ti, and 0.05%-0.5% of Zr by mass percentage.

Preferably, the content of Cu is 4.5%-6.5%, preferably 5.0%-6.0%.

Preferably, the content of Mg is 0.6%-1.0%, preferably 0.7%-0.9%.

Preferably, the content of Ag is 0.2%-0.6%, preferably 0.2%-0.4%.

Preferably, the content of Mn is 0.05%-0.4%, preferably 0.1%-0.3%.

Preferably, the content of Ti is 0.05%-0.3%, preferably 0.05%-0.15%.

Preferably, the content of Zr is 0.05%-0.2%, preferably 0.05%-0.15%.

In a specific embodiment, the matrix material includes the following components by mass percentage: 5.0%-6.0% of Cu, 0.7%-0.9% of Mg, 0.2%-0.4% of Ag, 0.1%-0.3% of Mn, 0.05%-0.15% of Ti, and 0.05%-0.15% of Zr, with the balance being Al.

Preferably, the reinforcing phase is SiC particles with a volume percentage of 15%-25%, preferably 18%-22%.

Preferably, the SiC particles are micrometer sized particles. Preferably, a size range of the SiC particles is 5 μm-50 μm, preferably 5 μm-25 μm. The use of SiC particles within this size range can significantly improve the wear resistance of the aluminum matrix composite material without affecting properties of the matrix such as the tensile strength. When using SiC particles below this size range, the improvement in wear resistance of the aluminum matrix composite material is limited and cannot meet the standards for use in brake systems. When using SiC particles above this size range, it is extremely difficult to control the interface bonding effect between the reinforcing phase and the matrix, leading to easy peeling of SiC particles during material service and exacerbating wear.

In the present disclosure, the addition of Cu element enables the formation of a stable strengthening phase (θ phase) with a low diffusion rate in the aluminum matrix composite material. The addition of Mg element can promote the formation of θ phase. Ag element can capture Mg atoms, forming Ag-Mg atomic clusters that can alter the nucleation mode of the main strengthening phase Al₂Cu (θ phase) in the Al—Cu—Mg alloy and form an Ω phase with better high-temperature resistance, further improving the high-temperature resistance of the alloy. The content of Ag element in the present disclosure is in a range from 0.1% to 0.8%. When the content of Ag element is below 0.1%, the effect on the precipitation of Ω phase is small, and the high-temperature performance of the material cannot be effectively strengthened. When the content of Ag element is above 0.8%, it cannot promote continuous precipitation of Ω phase, and the raw material cost is also greatly increased. Mn, Ti, and Zr elements can form a second phase with thermal stability in the aluminum matrix composite material while also refining the structure and strengthening the matrix material.

By conducting phase diagram analysis on alloys and conducting comprehensive research on the current study progress of heat-resistant aluminum alloys, the inventor has designed and prepared a matrix material with excellent high-temperature resistance by himself. The inventor conducted theoretical research on the phase diagrams of binary and ternary alloys such as Al—Cu, Al—Cu—Mg, and Al—Cu—Mn, and analyzed the solid solubility between each element and the Al matrix, and possible phases formed by the addition of each element; the influence of the addition of Ag element on the room temperature performance and high temperature performance of Al—Cu—Mg aluminum alloy was studied, so as to determine the appropriate proportion of addition of each element and design an appropriate heat treatment temperature range matrix on the phase diagrams. The design of the present disclosure has changed the type and volume fraction of the strengthening phase precipitated after aging heat treatment of Al—Cu—Mg alloy. The addition of Ag element provides a large number of nucleation sites for the strengthening phase (Ω phase), and further improves the room temperature performance and high temperature performance of the alloy system. The inventor found through research that Ag element has to be evenly dispersed in the matrix material to ensure that the high-performance strengthening phase (Ω phase) can be finally obtained.

The present disclosure also provides a method for preparing the above aluminum matrix composite material, including:
melting: mixing pure aluminum and aluminum-copper alloy according to set mass percentage content of each metal element in the matrix material, heating to melt all the metals, adding pure magnesium and pure silver, and obtaining a first metal melt after all the pure magnesium and pure silver have melted;
refining: slagging-off the first metal melt obtained, adding a refining agent and stirring, and obtaining a second metal melt after dredging the slags;
stirring the second metal melt obtained and controlling the temperature of the second metal melt to be 650° C.-700° C.;
adding SiC particles to the second metal melt at the temperature of 650° C.-700° C. under stirring;
after the addition of SiC particles is completed, lowering the temperature of the second metal melt to make the second metal in a semi-solid state, stirring and obtaining an aluminum matrix composite material melt;
after heating the aluminum matrix composite material melt obtained, casting the aluminum matrix composite material melt into a preheated casting mold, and obtaining an aluminum matrix composite material casting; and
performing heat treatment on the aluminum matrix composite material casting obtained.

Preferably, the melting step is carried out in a vacuum melting furnace.

Preferably, in the melting step, aluminum manganese alloys, aluminum titanium alloys, aluminum zirconium alloys are mixed with pure aluminum and aluminum copper alloys.

Preferably, the aluminum copper alloys are intermediate alloys such as Al-20Cu, Al-30Cu, or Al-40Cu; the aluminum manganese alloys are intermediate alloys such as Al-30Mn, Al-40Mn, or Al-50Mn; the aluminum titanium alloys are intermediate alloys such as Al-10Ti or Al-20Ti; and the aluminum zirconium alloys are intermediate alloys such as Al-10Zr. The pure magnesium is batched with a burning loss rate of approximately 10%-30%.

Preferably, in the melting step, the heating temperature is 680° C.-800° C. In this step, after the pure magnesium and pure silver are added, the temperature keeping time is 5 minutes-10 minutes to melt all the pure magnesium and pure silver.

Preferably, the refining agent may be a gas refining agent or a liquid refining agent; the gas refining agent may be nitrogen, argon, chlorine, freon or a mixture thereof, and the liquid refining agent may be hexachloroethane, carbon tetrachloride, titanium tetrachloride, or a mixture thereof.

Preferably, in the refining step, the stirring time is 3 minutes-10 minutes.

Preferably, the second metal melt obtained is vigorously stirred.

Preferably, the SiC particles are pre-treated before being used. The pre-treatment includes ultrasonic cleaning, drying and sieving for the SiC particles, and the SiC particles are preheated to 650° C.-700° C. The pre-treatment of SiC particles can improve the wettability between SiC particles and the matrix material, as well as the stability of dispersion of SiC particles in the metal melt, thereby improving the overall performance of the aluminum matrix composite material.

Preferably, in the step of preparing the aluminum matrix composite material melt, the temperature of the second metal melt is lowered to 580° C.-650° C., preferably to 620° C.-650° C., making the second metal melt in the semi-solid state. The viscosity of the melt at the semi-solid temperature significantly increases compared to that above the liquidus temperature. The viscosity of the melt represents the magnitude of internal friction force. Under the same stirring speed, the higher the viscosity of the melt, the larger the internal friction force formed. The large internal friction force in the melt can effectively crush the agglomeration of particles themselves, forming a sufficient shear force to ensure even dispersion of SiC particles. At the same time, due to the release of some latent heat of solidification in the range of 580° C.-650° C., the melt can be quickly cooled after casting; the matrix alloy has fine grains, so that the pushing and squeezing of SiC particles during the solidification process is reduced, improving the evenness of SiC particles and ultimately improving the wear resistance of the composite material. When stirring above the temperature range of the present disclosure, the internal friction force during stirring is greatly reduced, and there is no grinding and impact action of nascent β-Al on the agglomeration of SiC particles, leading to a decrease in the dispersibility of SiC particles. In addition, due to the decrease in viscosity, SiC particles are more likely to move and settle after stirring is stopped, leading to macroscopic unevenness and a sharp decrease in the wear resistance of the composite material. When stirring below the temperature range of the present disclosure, the melt is almost solid, and it is impossible to prepare the composite material.

Preferably, in the step of preparing the aluminum matrix composite material melt, the stirring speed is above 800 rpm, preferably 800 rpm-1000 rpm; and the stirring time is 15 minutes-30 minutes. When using this stirring process to prepare the heat-resistant aluminum matrix composite material, the velocity field and turbulent flow generated in the melt can just meet the stirring preparation of large-volume composite material, thus maintaining a relatively stable liquid level and reducing gas entrapment at the same time of achieving a strong shear effect.

In the present disclosure, SiC particles are added in the stirring process. After the addition of SiC particles is completed, the melt temperature is adjusted to the semi-solid range; by using the semi-solid stirring process, a heat-resistant aluminum matrix composite material with even distribution of SiC particles and good bonding with interface is finally produced.

Preferably, in the step of preparing the aluminum matrix composite material casting, the aluminum matrix composite material melt is heated to 650° C.-700° C.; and the preheating temperature of the casting mold is above 300° C.

Preferably, T6 heat treatment is performed on the aluminum matrix composite material casting. During T6 heat treatment, the solid solution temperature is 500° C.-540° C., the solid solution time is 8 hours-12 hours, the aging temperature is 170° C.-190° C., and the aging time is 3 hours-6 hours. The aluminum matrix composite material of the present disclosure is a typical heat-treatable reinforced aluminum alloy.

The present disclosure optimizes the various processes of the preparation of SiCp/Al Cu—Mg—Ag heat-resistant aluminum matrix composite material by selecting suitable elements, their contents, and the content of the reinforcing phase. A heat-resistant aluminum matrix composite material with even distribution of the reinforcing phase, excellent heat resistance, high wear resistance, high density, excellent room-temperature mechanical properties, and good structural performance after long-term exposure to heat is prepared, thereby solving the problems of uneven distribution of SiC particles, loose interface bonding, and high porosity that are likely to occur during the preparation of high-volume-fraction SiCp/Al—Cu—Mg—Ag composite material.

The present disclosure also provides a brake disc prepared from the aluminum matrix composite material.

The aluminum matrix composite material of the present disclosure is suitable for manufacturing brake discs of high-speed trains in rail transit and automobiles. Compared to existing composite materials of brake discs, the high-temperature resistance and wear resistance of the aluminum matrix composite material of the present disclosure are significantly improved. The aluminum matrix composite material of the present disclosure can also be used in various automotive braking systems, and has a significant unsprung weight reduction effect.

Compared to prior art, the present disclosure has the following advantageous effects:
the aluminum matrix composite material of the present disclosure has both excellent high-temperature resistance (such as high room-temperature strength, high fracture toughness, and high fatigue performance) and high wear resistance; its tensile strength is above 180 MPa at a high temperature of 300° C., and it can maintain a stable friction coefficient; the brake discs made of it can still meet service requirements in high-temperature environments. The present disclosure solves the problem that existing brake discs are prone to softening at high temperatures and therefore cannot be applied in the field of high-speed traffic braking systems.

### BRIEF DESCRIPTION OF THE DRAWINGS

FIG. 1 is a metallographic microscope image of the aluminum matrix composite material prepared in Example 1 of the present disclosure.

### DETAILED DESCRIPTION

In order to facilitate understanding the content described in the present disclosure, the technical solutions of the present disclosure will be further explained below in connection with specific examples; however, the present disclosure is not limited to this. All technologies implemented matrix on the above content of the present disclosure are covered within the scope of protection claimed by the present disclosure. Unless otherwise specified, the raw materials used in the examples are all commercially available goods. The instruments or operating steps not recorded in this document are all contents that can be routinely determined by those skilled in the art.

### Example 1

Melting: Industrial pure aluminum (27.72 kg), aluminum copper alloy (Al-20Cu, 10.8 kg), pure magnesium (0.36 kg), pure silver (0.12 kg), aluminum manganese alloy (Al-40Mn, 0.2 kg), aluminum titanium alloy (Al-10Ti, 0.4 kg), and aluminum zirconium alloy (Al-10Zr, 0.4 kg) are added into a vacuum melting furnace; after heating to 750° C. so that all the alloys are melted, pure magnesium and pure silver are added and the temperature is kept for 8 minutes to obtain a Al-5.4Cu-0.8Mg-0.3Ag-0.2Mn-0.1Ti-0.1Zr alloy melt (i.e., a first metal melt).

Refining: After slagging-off the first metal melt obtained in the melting step, a hexachloroethane refining agent is added, the melt is stirred for 5 minutes, and a second metal melt is obtained after dredging the slags.

A stirring device in the vacuum melting furnace is turned on to apply strong mechanical stirring to the melt, and the temperature of the second metal melt is controlled at 680° C.

10 kg of pre-treated SiC particles with an average size of 12 μm are added to the second metal melt with the temperature of 680° C. under stirring (the pre-treatment includes ultrasonic cleaning, drying, sieving, and preheating to 680° C.).

After the addition of SiC particles is completed, the temperature of the second metal melt is lowered to 620° C., and mechanical stirring is performed on the second metal melt in a semi-solid state for 20 minutes at a stirring speed of 1000 rpm to obtain an aluminum matrix composite material melt.

The stirred aluminum matrix composite material melt is heated to 660° C. and cast into a casting mold preheated to 400° C. to obtain an aluminum matrix composite material casting.

T6 heat treatment is performed on the aluminum matrix composite material casting obtained, with a solid solution temperature of 520° C., a solid solution time of 10 hours, an aging temperature of 180° C., and an aging time of 5 hours.

After measurement, the aluminum matrix composite material prepared in this example is composed of a matrix material and a reinforcing phase. The matrix material is composed of the following components: 5.4% of Cu, 0.8% of Mg, 0.3% of Ag, 0.2% of Mn, 0.1% of Ti, and 0.1% of Zr, with the balance being Al, each being measured matrix on the total weight of the matrix material; the reinforcing phase is 20% of SiC particles measured matrix on the total volume of the aluminum matrix composite material melt, with an average size of SiC particles being 12 μm.

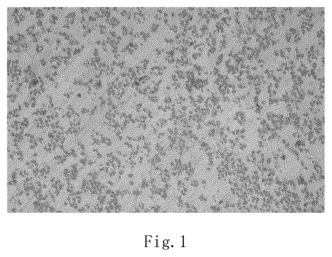

As shown in FIG. 1, in the aluminum matrix composite material of this example, SiC particles are evenly dispersed in the matrix material. The mechanical properties of the aluminum matrix composite material obtained after heat treatment were tested, and the tensile strength of the composite material reached 260 MPa at room temperature; at a high temperature of 300° C., the tensile strength stably remains above 180 MPa and the friction coefficient remains at 0.3.

### Example 2

Melting: Industrial pure aluminum (23.96 kg), aluminum copper alloy (Al-20Cu, 13 kg), pure magnesium (0.4 kg), pure silver (0.24 kg), aluminum manganese alloy (Al-40Mn, 0.4 kg), aluminum titanium alloy (Al-10Ti, 1.2 kg), and aluminum zirconium alloy (Al-10Zr, 0.8 kg) are added into a vacuum melting furnace; after heating to 750° C. so that all the alloys are melted, pure magnesium and pure silver are added and the temperature is kept for 8 minutes to obtain a Al-6.5Cu-1.0Mg-0.6Ag-0.4Mn-0.3Ti-0.2Zr alloy melt (i.e., a first metal melt).

Refining: After slagging-off the first metal melt obtained in the melting step, a hexachloroethane refining agent is added, the melt is stirred for 5 minutes, and a second metal melt is obtained after dredging the slags.

A stirring device in the vacuum melting furnace is turned on to apply strong mechanical stirring to the melt, and the temperature of the second metal melt is controlled at 680° C.

26.6 kg of pre-treated SiC particles with an average size of 12 μm are added to the second metal melt with the temperature of 680° C. under stirring (the pre-treatment includes ultrasonic cleaning, drying, sieving, and preheating to 680° C.).

After the addition of SiC particles is completed, the temperature of the second metal melt is lowered to 620° C., and mechanical stirring is performed on the second metal melt in a semi-solid state for 20 minutes at a stirring speed of 1000 rpm to obtain an aluminum matrix composite material melt.

The stirred aluminum matrix composite material melt is heated to 660° C. and cast into a casting mold preheated to 400° C. to obtain an aluminum matrix composite material casting.

T6 heat treatment is performed on the aluminum matrix composite material casting obtained, with a solid solution temperature of 520° C., a solid solution time of 10 hours, an aging temperature of 180° C., and an aging time of 5 hours.

After measurement, the aluminum matrix composite material prepared in this example is composed of a matrix material and a reinforcing phase. The matrix material is composed of the following components: 6.48% of Cu, 1.02% of Mg, 0.6% of Ag, 0.4% of Mn, 0.2% of Ti, and 0.2% of Zr, with the balance being Al, each being measured matrix on the total weight of the matrix material; the reinforcing phase is 40% of SiC particles measured matrix on the total volume of the aluminum matrix composite material melt, with an average size of SiC particles being 12 μm.

In the aluminum matrix composite material of this example, SiC particles are evenly dispersed in the matrix material. The mechanical properties of the aluminum matrix composite material obtained after heat treatment were tested, and the tensile strength of the composite material reached 265 MPa at room temperature; at a high temperature of 300° C., the tensile strength stably remains above 175 MPa and the friction coefficient remains at 0.33.

Described above are only preferred specific embodiments of the present disclosure, but the scope of protection of the present disclosure is not limited to this. Any changes or replacements that can be easily conceived by those skilled in the art within the technical scope disclosed by the present disclosure should be covered within the scope of protection of the present disclosure. Therefore, the scope of protection of the present disclosure should be accorded with the scope of protection of the claims.

1. An aluminum matrix composite material, comprising:
a matrix material, which comprises following components by mass percentage: 4.0%-7.0% of Cu, 0.4%-1.2% of Mg, 0.1%-0.8% of Ag, and balance being Al; and
a reinforcing phase, which is SiC particles with a volume percentage of 10%-40%.

2. The aluminum matrix composite material according to claim 1, further comprising 0.05%-0.5% of Mn, 0.05%-0.5% of Ti, and 0.05%-0.5% of Zr by mass percentage.

3. The aluminum matrix composite material according to claim 2, wherein the content of Mn is 0.05%-0.4%, the content of Ti is 0.05%-0.3%, and the content of Zr is 0.05%-0.2%.

4. The aluminum matrix composite material according to claim 1, wherein the content of Ag is 0.2%-0.6%, the content of Cu is 4.5%-6.5%, and the content of Mg is 0.6%-1.0%.

5. The aluminum matrix composite material according to claim 1, wherein a size of the SiC particle is 5 μm-50 μm.

6. A method for preparing the aluminum matrix composite material according to claim 1, comprising:
melting: mixing pure aluminum and aluminum-copper alloy according to a set mass percentage content of each metal element in the matrix material, heating to melt all the metals, adding pure magnesium and pure silver, and obtaining a first metal melt after all the pure magnesium and pure silver have melted;
refining: slagging-off the first metal melt obtained, adding a refining agent and stirring, and obtaining a second metal melt after dredging the slags;
stirring the second metal melt obtained and controlling the temperature of the second metal melt to be 650° C.-700° C.;
adding SiC particles to the second metal melt at the temperature of 650° C.-700° C. under stirring;
after the addition of SiC particles is completed, lowering the temperature of the second metal melt to make the second metal melt in a semi-solid state, stirring and obtaining an aluminum matrix composite material melt;
after heating the aluminum matrix composite material melt obtained, casting the aluminum matrix composite material melt into a preheated casting mold, and obtaining an aluminum matrix composite material casting; and
performing heat treatment on the aluminum matrix composite material casting obtained.

7. The method according to claim 6, wherein in the melting step, aluminum manganese alloys, aluminum titanium alloys, aluminum zirconium alloys are mixed with pure aluminum and aluminum copper alloys.

8. The method according to claim 6, wherein the SiC particles are pre-treated before being used; the pre-treatment comprises ultrasonic cleaning, drying and sieving for the SiC particles, and the SiC particles are preheated to 650° C.-700° C.

9. The method according to claim 6, wherein in the step of preparing the aluminum matrix composite material melt, the temperature of the second metal melt is lowered to 580° C.-650° C. to make the second metal melt in the semi-solid state; the stirring speed is above 800 rpm, and the stirring time is 15 minutes-30 minutes.

10. A brake disc, which is prepared from the aluminum matrix composite material according to claim 1.

11. A brake disc, which is prepared from an aluminum matrix composite material obtained using the method according to claim 6.
